(19) United States
(12) Patent Application Publication
(10) Pub. No.: US 2021/0097257 A1
(43) Pub. Date: Apr. 1, 2021

(54) SYSTEM AND METHOD FOR FINGERPRINT AUTHENTICATION

(71) Applicant: InvenSense, Inc., San Jose, CA (US)

(72) Inventors: Divi GUPTA, San Jose, CA (US); Art STEWART, San Jose, CA (US)

(73) Assignee: InvenSense, Inc., San Jose, CA (US)

(21) Appl. No.: 17/039,894

(22) Filed: Sep. 30, 2020

Related U.S. Application Data
(60) Provisional application No. 62/908,370, filed on Sep. 30, 2019.

(51) Int. Cl. G06K 9/00; G06F 21/32

(52) U.S. Cl. CPC G06K 9/00087; G06F 21/32; G06K 9/00114; G06K 9/00013

(57) ABSTRACT

A fingerprint authentication system includes a fingerprint imaging sensor and a spoof detector sensor. The fingerprint imaging sensor includes a two-dimensional array of ultrasonic transducers, where the fingerprint imaging sensor is for capturing an image of a fingerprint of a finger. The spoof detector sensor includes at least one ultrasonic transducer, where the spoof detector sensor is for capturing data used to determine whether the finger is a real finger. A contact layer overlies the fingerprint imaging sensor and the spoof detector sensor, where the contact layer for receiving the finger of a user. A processor of the fingerprint authentication system is configured to perform a user authentication operation using the fingerprint imaging sensor and the spoof detector sensor, where the user authentication operation is for authenticating a user using a single touch action.

### RELATED APPLICATION

This application claims priority to and the benefit of co-pending U.S. Provisional Patent Application 62/908,370, filed on Sep. 30, 2019, entitled “SYSTEM AND METHOD FOR FINGERPRINT LIVENESS DETECTION,” by Gupta, et al., having Attorney Docket No. IVS-932-PR, and assigned to the assignee of the present application, which is incorporated herein by reference in its entirety.

### BACKGROUND

Fingerprint sensors have become ubiquitous in mobile devices as well as other devices (e.g., locks on cars and buildings) and applications for authenticating a user's identity. They provide a fast and convenient way for the user to unlock a device, provide authentication for payments, etc. It is essential that fingerprint sensors operate at a level of security that, at a minimum, reduces the potential for circumvention of security of fingerprint authentication. For instance, fake fingers having fake or spoofed fingerprints can be used to attempt to circumvent fingerprint authentication at fingerprint sensors.

### BRIEF DESCRIPTION OF THE DRAWINGS

The accompanying drawings, which are incorporated in and form a part of the Description of Embodiments, illustrate various non-limiting and non-exhaustive embodiments of the subject matter and, together with the Description of Embodiments, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 is a block diagram of an example electronic device upon which embodiments described herein may be implemented.

FIGS. 2A through 2F illustrate examples of a fingerprint sensing system having different configurations of a fingerprint imaging sensor and a spoof detector sensor, according to some embodiments.

FIGS. 3A through 3D illustrate example hardware configurations of a fingerprint sensing system, according to various embodiments.

FIGS. 4A through 4C illustrate example configurations of the operation of the fingerprint imaging sensor and a spoof detector sensor in conjunction with an authentication module, according to various embodiments.

FIG. 5 illustrates an example data flow diagram for user authentication using a fingerprint imaging sensor and a spoof detector sensor, according to some embodiments.

FIG. 6 illustrates an example of a fingerprint sensing system configured to determine a location of a finger in determining liveness, according to some embodiments.

FIG. 7 illustrates an example process for authenticating a fingerprint at a fingerprint authentication system, according to some embodiments.

FIG. 8 illustrates an example process for performing a user authentication operation, according to some embodiments.

### DESCRIPTION OF EMBODIMENTS

The following Description of Embodiments is merely provided byway of example and not of limitation. Furthermore, there is no intention to be bound by any expressed or implied theory presented in the preceding background or in the following Description of Embodiments.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Some portions of the detailed descriptions which follow are presented in terms of procedures, logic blocks, processing and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of acoustic (e.g., ultrasonic) signals capable of being transmitted and received by an electronic device and/or electrical or magnetic signals capable of being stored, transferred, combined, compared, and otherwise manipulated in an electrical device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “capturing,” “performing,” “determining,” “detecting,” “interacting,” “imaging,” “operating,” “activating,” “triggering,” “confirming,” “weighting,” “matching,” “using,” “comparing,” “executing,” or the like, refer to the actions and processes of an electronic device such as an electrical device.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example fingerprint sensing and spoof detection system and/or mobile electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Discussion begins with a description of an example electronic device including a fingerprint sensor, upon which described embodiments can be implemented. An example system for fingerprint authentication using a fingerprint imaging sensor and a spoof detector sensor is then described, in accordance with various embodiments. Example operations for operating a system for fingerprint authentication using a fingerprint imaging sensor and a spoof detector sensor are then described.

Fingerprint sensors are used in electronic devices for user authentication, such as mobile electronic devices and applications operating on mobile electronic devices, locks for accessing cars or buildings, for protecting against unauthorized access to the devices and/or applications. Authentication of a fingerprint at a fingerprint sensor is performed before providing access to a device and/or application. The fingerprint sensor may be based on different principles such as capacitive, optical, or ultrasound technologies. To authenticate the user, a fingerprint captured by the fingerprint sensor is compared to registered fingerprint images of authenticated users that were acquired during an enrollment process.

In order to circumvent fingerprint authentication, attempts can be made to copy or spoof fingerprints of an authorized user using a fake or artificial finger. As such, fingerprint sensors should be capable of distinguishing real fingers from fake, artificial, or even dead fingers, also referred to herein as performing “spoof detection,” “fake finger detection,” or “liveness detection.” A “spoofed” fingerprint is a fake or artificial fingerprint that is used to attempt to circumvent security measures requiring fingerprint authentication. For example, an artificial finger may be used to gain unauthorized access to the electronic device or application, by making an unauthorized copy of the fingerprint of an authorized user, e.g., “spoofing” an actual fingerprint. The spoof detection may be performed by analyzing fingerprint images captured by the fingerprint sensor, e.g., performing biometric analysis of the fingerprint images, or looking at any characteristics that can help distinguish a fake/spoof fingerprint from a real fingerprint. These characteristics may be static features or dynamic features which have a certain time dependency because they change over time.

Many existing fingerprint sensor systems perform fingerprint acquisition and liveness detection using a single sensor. However, combining both functionalities in a single sensor may require compromises that negatively impact performance and may not achieve optimal performance of both the fingerprint imaging function and the spoof detection function. In this disclosure, novel systems and methods are described in which the fingerprint imaging functionality and the spoof detection functionality are separated. The embodiments described herein include a fingerprint sensor systems that combines a fingerprint sensor used to capture an image of the fingerprint with a spoof detection sensor used to perform the spoof detection to validate the finger is not a fake or spoof but a real finger. Although in this disclosure the focus is on detecting fingerprint, it should be appreciated that the techniques described herein may also be applied to areas of the body.

In accordance with the various embodiments, a fingerprint authentication system including a fingerprint imaging sensor and a spoof detector sensor is described. In some embodiments, the fingerprint imaging sensor and/or the spoof detector sensor are ultrasonic sensors. In some embodiments, the fingerprint imaging sensor includes a two-dimensional array of ultrasonic transducers, where the fingerprint imaging sensor is for capturing an image of a fingerprint of a finger. In some embodiments, the spoof detector sensor includes at least one ultrasonic transducer, where the spoof detector sensor is for capturing data used to determine whether the finger is a real finger. A contact layer overlies the fingerprint imaging sensor and the spoof detector sensor, where the contact layer is for receiving the finger of a user. A processor of the fingerprint authentication system is configured to perform a user authentication operation using the fingerprint imaging sensor and the spoof detector sensor, where the user authentication operation is for authenticating a user using a single touch action.

In one embodiment, the single touch action is a single contact between the finger and the fingerprint authentication system. In some embodiments, the layout of the contact layer, the fingerprint imaging sensor and the spoof detector sensor is such that the finger interacts with both the fingerprint imaging sensor and the spoof detector sensor during the user authentication operation using the single touch action. In some embodiments, the fingerprint imaging sensor and the spoof detector sensor operate concurrently during a single contact between the finger and the fingerprint authentication system. In some embodiments, the fingerprint imaging sensor triggers activation of the spoof detector sensor during the user authentication operation in response to detecting the finger interacting with the fingerprint authentication system. In some embodiments, the spoof detector sensor triggers activation of the fingerprint imaging sensor during the user authentication operation in response to determining that the finger is a real finger during the single touch action.

In some embodiments, the user authentication operation includes performing a matching operation comparing the image of the fingerprint captured at the fingerprint imaging sensor to a stored fingerprint image of an authenticated user. Confirmation that the image of the fingerprint is from a real finger based on the data used to determine whether the finger is a real finger captured at the spoof detector sensor is performed. In some embodiments, the fingerprint imaging sensor also captures data used to determine whether the finger is a real finger. In some embodiments, the user authentication operation includes weighting the data used to determine whether the finger is a real finger captured at the fingerprint imaging sensor differently than the data used to determine whether the finger is a real finger captured at the spoof detector sensor. In some embodiments, the spoof detector sensor also captures signal characteristics data for use during the matching operation of the user authentication operation. In some embodiments, the user authentication operation includes using a location of the finger relative to the fingerprint imaging sensor and the spoof detector sensor in performing user authentication.

### Example Mobile Electronic Device

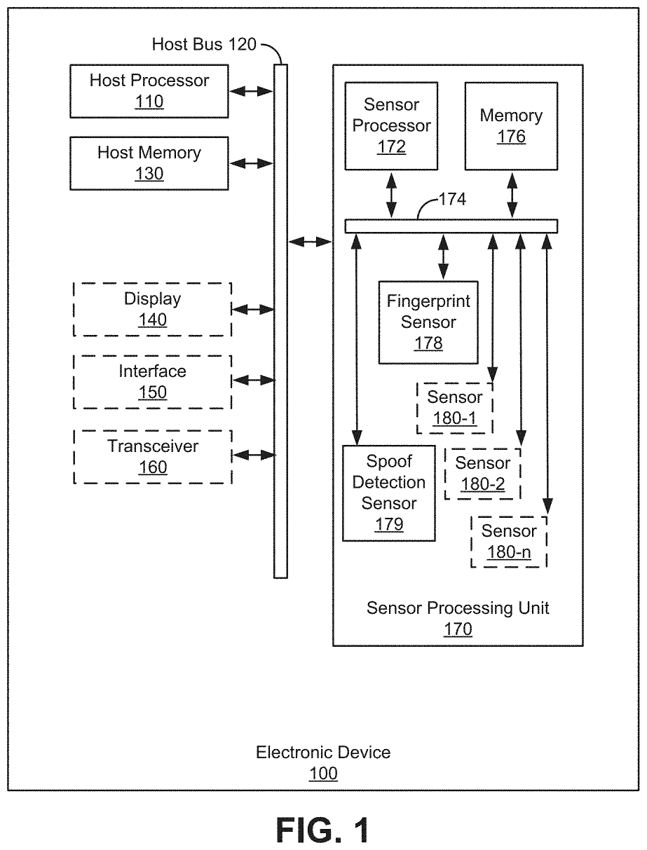

Turning now to the figures, FIG. 1 is a block diagram of an example electronic device 100. As will be appreciated, electronic device 100 may be implemented as a device or apparatus, such as a handheld mobile electronic device. For example, such a mobile electronic device may be, without limitation, a mobile telephone phone (e.g., smartphone, cellular phone, a cordless phone running on a local network, or any other cordless telephone handset), a wired telephone (e.g., a phone attached by a wire), a personal digital assistant (PDA), a video game player, video game controller, a Head Mounted Display (HMD), a virtual or augmented reality device, a navigation device, an activity or fitness tracker device (e.g., bracelet, clip, band, or pendant), a smart watch or other wearable device, a mobile internet device (MID), a personal navigation device (PND), a digital still camera, a digital video camera, a portable music player, a portable video player, a portable multi-media player, a remote control, health monitoring device, wellness monitoring device, medical device, or a combination of one or more of these devices. In other embodiments, electronic device 100 may be implemented as a fixed electronic device, such as and without limitation, an electronic lock, a doorknob, a car start button, an automated teller machine (ATM), etc. In accordance with various embodiments, electronic device 100 is capable of reading fingerprints.

As depicted in FIG. 1, electronic device 100 may include a host processor 110, a host bus 120, a host memory 130, and a sensor processing unit 170. Some embodiments of electronic device 100 may further include one or more of a display device 140, an interface 150, a transceiver 160 (all depicted in dashed lines) and/or other components. In various embodiments, electrical power for electronic device 100 is provided by a mobile power source such as a battery (not shown), when not being actively charged.

Host processor 110 can be one or more microprocessors, central processing units (CPUs), DSPs, general purpose microprocessors, ASICs, ASIPs, FPGAs or other processors which run software programs or applications, which may be stored in host memory 130, associated with the functions and capabilities of electronic device 100.

Host bus 120 may be any suitable bus or interface to include, without limitation, a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, a serial peripheral interface (SPI) or other equivalent. In the embodiment shown, host processor 110, host memory 130, display 140, interface 150, transceiver 160, sensor processing unit (SPU) 170, and other components of electronic device 100 may be coupled communicatively through host bus 120 in order to exchange commands and data. Depending on the architecture, different bus configurations may be employed as desired. For example, additional buses may be used to couple the various components of electronic device 100, such as by using a dedicated bus between host processor 110 and memory 130.

Host memory 130 can be any suitable type of memory, including but not limited to electronic memory (e.g., read only memory (ROM), random access memory, or other electronic memory), hard disk, optical disk, or some combination thereof. Multiple layers of software can be stored in host memory 130 for use with/operation upon host processor 110. For example, an operating system layer can be provided for electronic device 100 to control and manage system resources in real time, enable functions of application software and other layers, and interface application programs with other software and functions of electronic device 100. Similarly, a user experience system layer may operate upon or be facilitated by the operating system. The user experience system may comprise one or more software application programs such as menu navigation software, games, device function control, gesture recognition, image processing or adjusting, voice recognition, navigation software, communications software (such as telephony or wireless local area network (WLAN) software), and/or any of a wide variety of other software and functional interfaces for interaction with the user can be provided. In some embodiments, multiple different applications can be provided on a single electronic device 100, and in some of those embodiments, multiple applications can run simultaneously as part of the user experience system. In some embodiments, the user experience system, operating system, and/or the host processor 110 may operate in a low-power mode (e.g., a sleep mode) where very few instructions are processed. Such a low-power mode may utilize only a small fraction of the processing power of a full-power mode (e.g., an awake mode) of the host processor 110.

Display 140, when included, may be a liquid crystal device, (organic) light emitting diode device, or other display device suitable for creating and visibly depicting graphic images and/or alphanumeric characters recognizable to a user. Display 140 may be configured to output images viewable by the user and may additionally or alternatively function as a viewfinder for camera. It should be appreciated that display 140 is optional, as various electronic devices, such as electronic locks, doorknobs, car start buttons, etc., may not require a display device.

Interface 150, when included, can be any of a variety of different devices providing input and/or output to a user, such as audio speakers, touch screen, real or virtual buttons, joystick, slider, knob, printer, scanner, computer network I/O device, other connected peripherals and the like.

Transceiver 160, when included, may be one or more of a wired or wireless transceiver which facilitates receipt of data at electronic device 100 from an external transmission source and transmission of data from electronic device 100 to an external recipient. By way of example, and not of limitation, in various embodiments, transceiver 160 comprises one or more of: a cellular transceiver, a wireless local area network transceiver (e.g., a transceiver compliant with one or more Institute of Electrical and Electronics Engineers (IEEE) 802.11 specifications for wireless local area network communication), a wireless personal area network transceiver (e.g., a transceiver compliant with one or more IEEE 802.15 specifications for wireless personal area network communication), and a wired a serial transceiver (e.g., a universal serial bus for wired communication).

Electronic device 100 also includes a sensor assembly in the form of integrated Sensor Processing Unit (SPU) 170 which includes sensor processor 172, memory 176, a fingerprint sensor 178, spoof detection sensor 179, and a bus 174 for facilitating communication between these and other components of SPU 170. In some embodiments, SPU 170 may include at least one additional sensor 180 (shown as sensor 180-1, 180-2, . . . 180-n) communicatively coupled to bus 174. In some embodiments, at least one additional sensor 180 is a force or pressure sensor (e.g. a touch sensor) configured to determine a force or pressure or a temperature sensor configured to determine a temperature at electronic device 100. The force or pressure sensor may be disposed within, under, or adjacent fingerprint sensor 178 and/or spoof detection sensor 179. In some embodiments, all of the components illustrated in SPU 170 may be embodied on a single integrated circuit. It should be appreciated that SPU 170 may be manufactured as a stand-alone unit (e.g., an integrated circuit), that may exist separately from a larger electronic device and is coupled to host bus 120 through an interface (not shown). It should be appreciated that, in accordance with some embodiments, that SPU 170 can operate independent of host processor 110 and host memory 130 using sensor processor 172 and memory 176.

Sensor processor 172 can be one or more microprocessors, CPUs, DSPs, general purpose microprocessors, ASICs, ASIPs, FPGAs or other processors which run software programs, which may be stored in memory 176, associated with the functions of SPU 170. It should also be appreciated that fingerprint sensor 178, spoof detection sensor 179, and additional sensor 180, when included, may also utilize processing and memory provided by other components of electronic device 100, e.g., host processor 110 and host memory 130.

Bus 174 may be any suitable bus or interface to include, without limitation, a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, a serial peripheral interface (SPI) or other equivalent. Depending on the architecture, different bus configurations may be employed as desired. In the embodiment shown, sensor processor 172, memory 176, fingerprint sensor 178, and other components of SPU 170 may be communicatively coupled through bus 174 in order to exchange data.

Memory 176 can be any suitable type of memory, including but not limited to electronic memory (e.g., read only memory (ROM), random access memory, or other electronic memory). Memory 176 may store algorithms or routines or other instructions for processing data received from fingerprint sensor 178 and/or one or more sensor 180, as well as the received data either in its raw form or after some processing. Such algorithms and routines may be implemented by sensor processor 172 and/or by logic or processing capabilities included in fingerprint sensor 178, spoof detection sensor 179, and/or sensor 180.

A sensor 180 may comprise, without limitation: a temperature sensor, touch sensor, a humidity sensor, an atmospheric pressure sensor, an infrared sensor, a radio frequency sensor, a navigation satellite system sensor (such as a global positioning system receiver), an acoustic sensor (e.g., a microphone), an inertial or motion sensor (e.g., a gyroscope, accelerometer, or magnetometer) for measuring the orientation or motion of the sensor in space, or other type of sensor for measuring other physical or environmental factors. In one example, sensor 180-1 may comprise an acoustic sensor, sensor 180-2 may comprise a temperature sensor, and sensor 180-n may comprise a motion sensor.

In some embodiments, fingerprint sensor 178, spoof detection sensor 179, and/or one or more sensors 180 may be implemented using a microelectromechanical system (MEMS) that is integrated with sensor processor 172 and one or more other components of SPU 170 in a single chip or package. It should be appreciated that fingerprint sensor 178 and or spoof detection sensor 179 may be disposed behind display 140. Although depicted as being included within SPU 170, one, some, or all of fingerprint sensor 178, spoof detection sensor 179, and/or one or more sensors 180 may be disposed externally to SPU 170 in various embodiments. It should be appreciated that fingerprint sensor 178 can be any type of fingerprint sensor, including without limitation, an ultrasonic sensor, an optical sensor, a camera, etc.

### Example System for Fingerprint Authentication Using a Fingerprint Imaging Sensor and a Spoof Detector Sensor

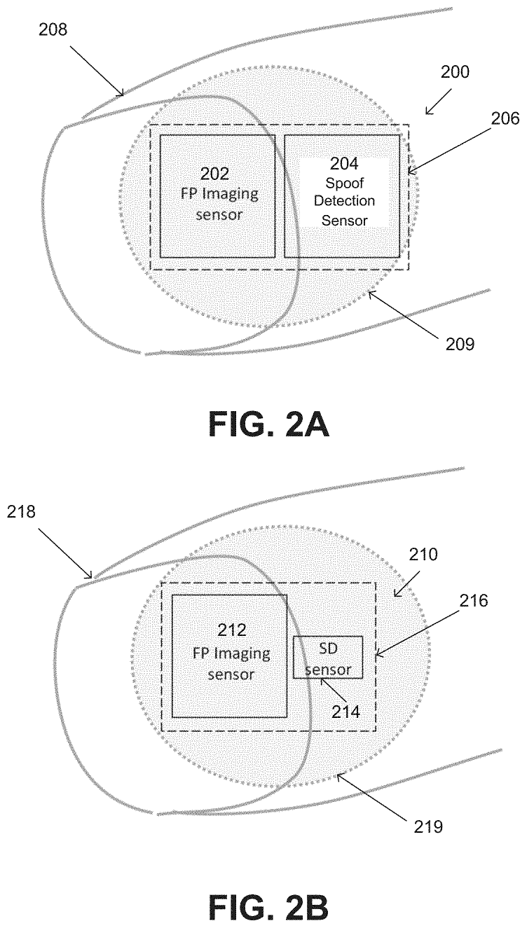

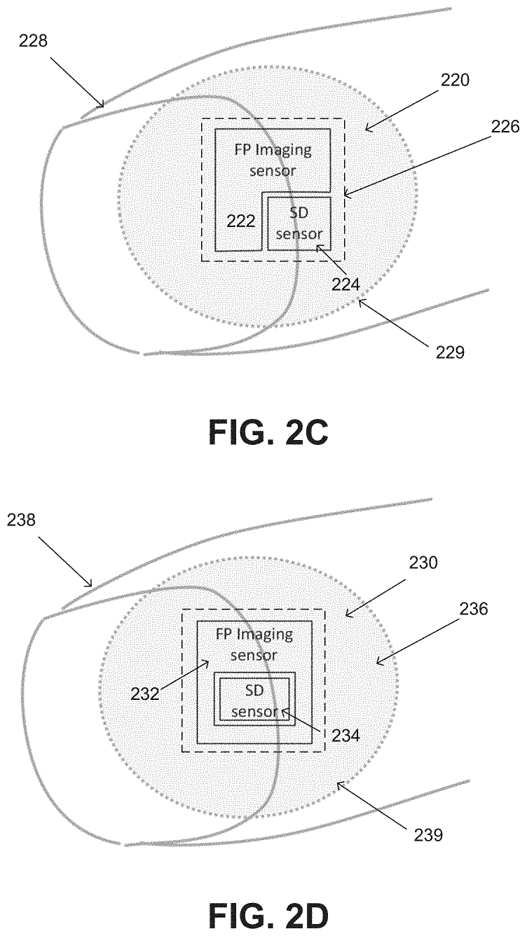

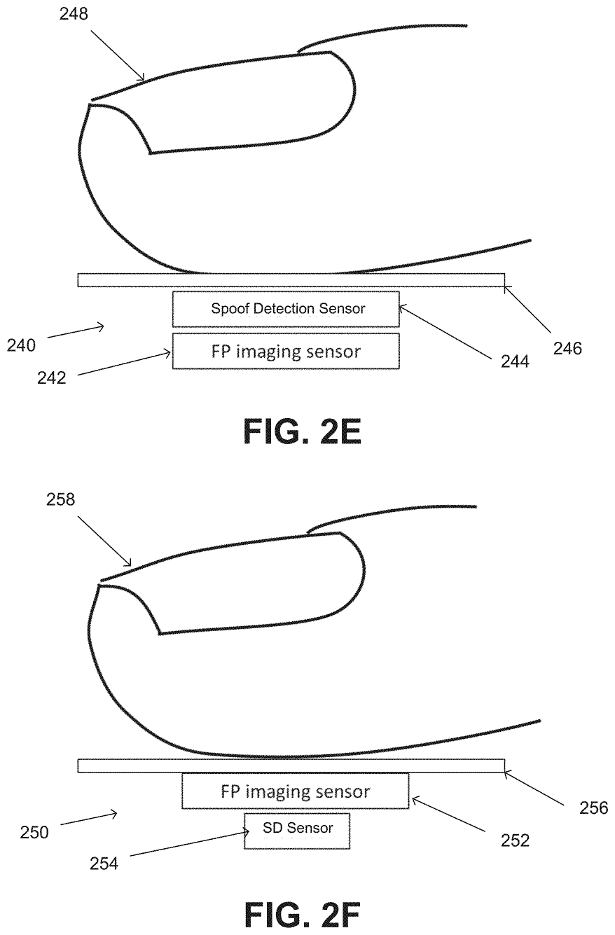

FIGS. 2A through 2F illustrate examples of a fingerprint sensing system having different configurations of a fingerprint imaging sensor and a spoof detector sensor, according to some embodiments. As described herein, the fingerprint sensing system of the described embodiments include a sensor for capturing a fingerprint and a sensor for capturing data for use in making a spoof (e.g., liveness) determination. The sensor used for capturing a fingerprint image may further be referred to herein as a fingerprint imaging sensor, a fingerprint image sensor, or an image sensor, and the sensor used for liveness detection may be referred to as a spoof detection sensor or a liveness sensor.

Embodiments of the described fingerprint sensing system are configured to perform the user authentication and liveness determination in one touch of the finger on the contact layer of the fingerprint sensing system, also referred to herein as a “single touch action.” The single touch action described herein is a single contact between the finger and the fingerprint sensing system (e.g., the time between a user placing a finger on the fingerprint sensing system and removing of the finger from contact with the fingerprint sensing system. In order to perform both user authentication and liveness determination during a single touch action, embodiments described herein provide for the spatial distribution of an fingerprint imaging sensor and a spoof detection sensor to preclude against, or at least make highly difficult, deception or circumvention of the fingerprint sensing system. For example, by putting a fake finger with the correct ridge/valley pattern on the fingerprint imaging sensor and putting another real finger with an incorrect ridge/valley pattern on the spoof detection sensor, a fingerprint sensing system may be circumvented in that the fingerprint may be authenticated and a real finger may be detected, despite the fingerprint not coming from the real finger. Therefore, the layout/design of the fingerprint sensing system should prevent these scenarios and ensure it is the same finger that is put on both sensors at the same time, in one touch. For some sensor techniques, a contact between the sensor and the finger is needed, e.g., ultrasonic sensors. For other sensors such a contact may not be needed, but rather an interaction with the fingerprint sensing system may only be needed.

In accordance with the described embodiments, the fingerprint imaging sensor creates a representation of the ridge/valley pattern of a user's fingerprint via a variety of different imaging modalities such as capacitive, optical or acoustic imaging. The ridge/valley pattern often represents a visual image of the fingerprint and its valley-ridge pattern. For the spoof detection sensor, unique characteristics of human physiology are collected that may not be observable via the epidermis or via the fingerprint imaging sensor. The spoof detection sensor may output a likelihood or confidence that the finger is a real finger, without providing any image, ridge/valley pattern or other two-dimensional pattern, or other spatial information.

FIG. 2A illustrates an example embodiment of fingerprint sensing system 200 where the fingerprint imaging sensor 202 and spoof detection sensor 204 are positioned next to each other, and that fingerprint imaging sensor 202 and spoof detection sensor 204 may be of approximately equal size. Although fingerprint imaging sensor 202 and spoof detection sensor 204 are shown as squares, fingerprint imaging sensor 202 and spoof detection sensor 204 may have any other form factors, e.g., rectangular, circular, etc. The dashed box 206 indicates that both fingerprint imaging sensor 202 and spoof detection sensor 204 may be combined together on one substrate and/or in one package. The dotted ellipse 209 represents the region of the surface of the finger 208 that interacts with both fingerprint imaging sensor 202 and spoof detection sensor 204 (e.g., the contact area between finger 208 and the contact layer).

In some embodiments, e.g., fingerprint imaging sensor 202 and spoof detection sensor 204 underlie a common contact layer also represented by the dashed box 206. In such an embodiment, dotted ellipse 209 represents the region of the surface of the finger 208 that makes contact with the contact layer and interacts with both fingerprint imaging sensor 202 and spoof detection sensor 204. As shown, both fingerprint imaging sensor 202 and spoof detection sensor 204 underlie the contact layer and the region of the surface of the finger 208 that makes contact with the contact layer.

FIG. 2B illustrates an example embodiment of fingerprint sensing system 210 where the fingerprint imaging sensor 212 and spoof detection sensor 214 are positioned next to each other, but are of different sizes. Although in this embodiment fingerprint imaging sensor 212 is represented larger than spoof detection sensor 214, the inverse is also possible, where spoof detection sensor 214 is larger than fingerprint imaging sensor 212. It should be appreciated that in some embodiments, fingerprint imaging sensor 212 needs to be of a certain minimum size because enough of the fingerprint needs to be captured to guarantee a certain matching confidence. For example, a minimum surface of about 10 mm² may be needed. For reasonable strength matching fingerprint imaging sensor 212 may need to capture a ridge/valley pattern about 10 mm². For spoof detection sensor 214, no such minimum surface requirements may be necessary since spoof detection sensor 214 does not need to acquire spatial information (e.g., a ridge/valley pattern). As such, a small spoof detection sensor 214 with a sensor surface area below the approximate 10 mm² needed for matching, e.g., between 0.5-5 mm², may be used. In other words, the spoof detection sensor 214 may have a sensor surface smaller than the minimum required surface for a normal fingerprint imaging sensor 212. The fingerprint imaging sensor 212 and spoof detection sensor 214 may be positioned at any desirable spacing from each other as long as the user finger can cover the sensor in one touch, for reasons discussed above.

The dashed box 216 indicates that both fingerprint imaging sensor 212 and spoof detection sensor 214 may be combined together on one substrate and/or in one package. The dotted ellipse 219 represents the region of the surface of the finger 218 that interacts with both fingerprint imaging sensor 212 and spoof detection sensor 214.

In some embodiments, e.g., where fingerprint imaging sensor 212 is an ultrasonic imaging sensor, fingerprint imaging sensor 212 and spoof detection sensor 214 underlie a common contact layer also represented by the dashed box 216. In such an embodiment, dotted ellipse 219 represents the region of the surface of the finger 218 that makes contact with the contact layer and interacts with both fingerprint imaging sensor 212 and spoof detection sensor 214. As shown, both fingerprint imaging sensor 212 and spoof detection sensor 214 underlie the contact layer and the region of the surface of the finger 218 that makes contact with the contact layer.

FIG. 2C illustrates an example embodiment of fingerprint sensing system 220 where the fingerprint imaging sensor 222 and spoof detection sensor 224 are integrated together. As illustrated, fingerprint sensing system 220 is of a square or rectangular shape, and fingerprint imaging sensor 222 is shaped such that there is an exterior cut-out allowing for placement of spoof detection sensor 224. Although fingerprint sensing system 220, fingerprint imaging sensor 222 and spoof detection sensor 224 are shown as squares, fingerprint imaging sensor 222 and spoof detection sensor 224 may have any other form factors, e.g., rectangular, circular, etc. The dashed box 226 indicates that both fingerprint imaging sensor 222 and spoof detection sensor 224 may be combined together on one substrate and/or in one package. The dotted ellipse 229 represents the region of the surface of the finger 208 that interacts with both fingerprint imaging sensor 222 and spoof detection sensor 224

In some embodiments, e.g., where fingerprint imaging sensor 222 is an ultrasonic imaging sensor, fingerprint imaging sensor 222 and spoof detection sensor 224 underlie a common contact layer also represented by the dashed box 226. In such an embodiment, dotted ellipse 229 represents the region of the surface of the finger 228 that makes contact with the contact layer and interacts with both fingerprint imaging sensor 222 and spoof detection sensor 224. As shown, both fingerprint imaging sensor 222 and spoof detection sensor 224 underlie the contact layer and the region of the surface of the finger 228 that makes contact with the contact layer.

FIG. 2D illustrates an example embodiment of fingerprint sensing system 230 where the fingerprint imaging sensor 232 and spoof detection sensor 234 are integrated together. As illustrated, fingerprint sensing system 230 is of a square or rectangular shape, and fingerprint imaging sensor 232 is shaped such that there is an interior cut-out allowing for placement of spoof detection sensor 234. Although fingerprint sensing system 230, fingerprint imaging sensor 232 and spoof detection sensor 234 are shown as squares and rectangles, fingerprint imaging sensor 232 and spoof detection sensor 234 may have any other form factors, e.g., rectangular, circular, etc. The dashed box 236 indicates that both fingerprint imaging sensor 232 and spoof detection sensor 234 may be combined together on one substrate and/or in one package. The dotted ellipse 239 represents the region of the surface of the finger 208 that interacts with both fingerprint imaging sensor 232 and spoof detection sensor 234

In some embodiments, e.g., where fingerprint imaging sensor 232 is an ultrasonic imaging sensor, fingerprint imaging sensor 232 and spoof detection sensor 234 underlie a common contact layer also represented by the dashed box 236. In such an embodiment, dotted ellipse 239 represents the region of the surface of the finger 238 that makes contact with the contact layer and interacts with both fingerprint imaging sensor 232 and spoof detection sensor 234. As shown, both fingerprint imaging sensor 232 and spoof detection sensor 234 underlie the contact layer and the region of the surface of the finger 238 that makes contact with the contact layer.

With reference to FIGS. 2A through 2D, the fingerprint imaging sensors and the spoof detection sensors may be interchanged in the design and their relative sizes, dimensions, shapes, and form factors may be different. In general, a space or area is reserved in one sensor in order to accommodate the other sensor. The fingerprint imaging sensors and the spoof detection sensors may be on the same substrate, and may be distributionally integrated. The sensors in the embodiments of FIGS. 2A through 2D may be positioned in the same plane, and may be mounted on a single substrate of support, or fingerprint imaging sensors and the spoof detection sensors may have separate substrates or support.

FIGS. 2E and 2F illustrates example embodiments of fingerprint sensing systems in which the fingerprint imaging sensors and the spoof detection sensors are stacked or partially stacked. Stacking the fingerprint imaging sensor and the spoof detection sensor provides a robust solution that restricts the ability of a user to circumvent the fingerprint sensing system.

FIG. 2E illustrates a side view of an embodiment of fingerprint sensing system 240 in which spoof detection sensor 244 is stacked over fingerprint imaging sensor 242. In some embodiments, fingerprint sensing system 240 includes contact layer 246. It should be appreciated that fingerprint imaging sensor 242 and spoof detection sensor 244 may have any form factors, e.g., square, rectangular, circular, etc. In some embodiments, e.g., where fingerprint imaging sensor 242 is an ultrasonic imaging sensor, fingerprint imaging sensor 242 and spoof detection sensor 244 underlie a common contact layer 246. In such an embodiment, finger 248 makes contact with the contact layer 246 and interacts with both fingerprint imaging sensor 242 and spoof detection sensor 244.

FIG. 2F illustrates a side view of an embodiment of fingerprint sensing system 250 in which fingerprint imaging sensor 252 is stacked over spoof detection sensor 254. In some embodiments, fingerprint sensing system 250 includes contact layer 256. It should be appreciated that fingerprint imaging sensor 252 and spoof detection sensor 254 may have any form factors, e.g., square, rectangular, circular, etc. In some embodiments, e.g., where fingerprint imaging sensor 252 is an ultrasonic imaging sensor, fingerprint imaging sensor 252 and spoof detection sensor 254 underlie a contact layer 256. In such an embodiment, finger 258 makes contact with the contact layer 256 and interacts with both fingerprint imaging sensor 252 and spoof detection sensor 254.

With reference to FIGS. 2E and 2F, it should be appreciated that the fingerprint imaging sensor and the spoof detection sensor may be interchanged in the design and their relative sizes, dimensions, shapes, and form factors may be different. The stacking order may be adapted based on the technology that is used, since the lower sensor should be able to function through the upper sensor. Although in all example embodiments only a single image sensor and a single liveness sensor are shown, a plurality of image sensors and/or a plurality of liveness sensors may be used. For example, an image sensor may be coupled with a plurality of liveness sensors.

The fingerprint imaging sensors described herein may be any type of fingerprint sensor used to capture a fingerprint image, e.g., a capacitive fingerprint sensor, an optical fingerprint sensor, or an ultrasonic fingerprint sensor. For ultrasonic sensors, the design may be using a film based piezoelectric material (PVDF-like) or may be using an array of ultrasonic transducers. The ultrasonic transducers may be MEMS-type transducers, for example, using piezoelectric membranes to generate ultrasonic waves. These membranes may have internal support structures in addition to the edge support structures. The piezoelectric materials used may be any material known to the person skilled in the art, such as PZT, Aluminum Nitrate, with or without Sc doping, etc. A minimum dimension is required in order to provide a sufficiently larger area of the fingerprint to compare the captured fingerprint image with the previous stored fingerprint image (template) during enrollment. The exact requirement of the surface and minimum dimension may depend on the fingerprint matching process and the algorithms used. The requirements, for both sensors, may further depend on the required level of security.

The spoof detection sensors described herein may be any type of sensor that can provide an indication of liveness of the finger on the sensor. The liveness indication may be based on the detection of the characteristics of live human tissue, bones, blood vessels, or any other type of structures, and their interactions with the sensor. This type of liveness may be considered static liveness. The liveness indication may also be based on a dynamic liveness, such as the detection of a pulse, heartbeat, blood flow, etc. As understood by one of ordinary skill in the art, ultrasonic signals as a function of depth are different for real fingers than fake/spoofed fingers. Any other type of dynamic characteristic that requires data acquisition for a certain window of time may be used. In some embodiments, the spoof detection sensor does not provide localized information (non-spatial data), for example the spoof detection sensor may not provide a spatial representation of the ridge/valley pattern. The term localized information refers to an imaging capability. The fingerprint imaging sensor does provide localized information in the form of a fingerprint image. The spoof detection sensor may not have any imaging capability, and it may only provide a liveness indication. In various embodiments, the fingerprint imaging sensor provides an image of the fingerprint, while the spoof detection sensor does not provide an image, but only a liveness indication. This liveness indication may be without any spatial information. The fingerprint imaging sensor and spoof detection sensor are complimentary, since the fingerprint imaging sensor is used for authentication, and the spoof detection sensor is used to make sure the obtained fingerprint image is from a real finger and not from a fake or spoof finger.

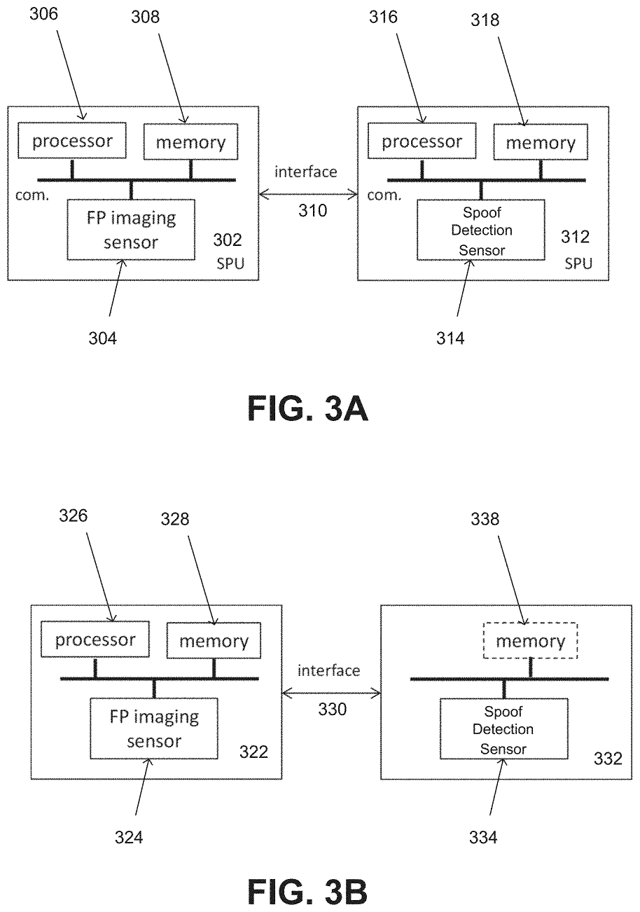

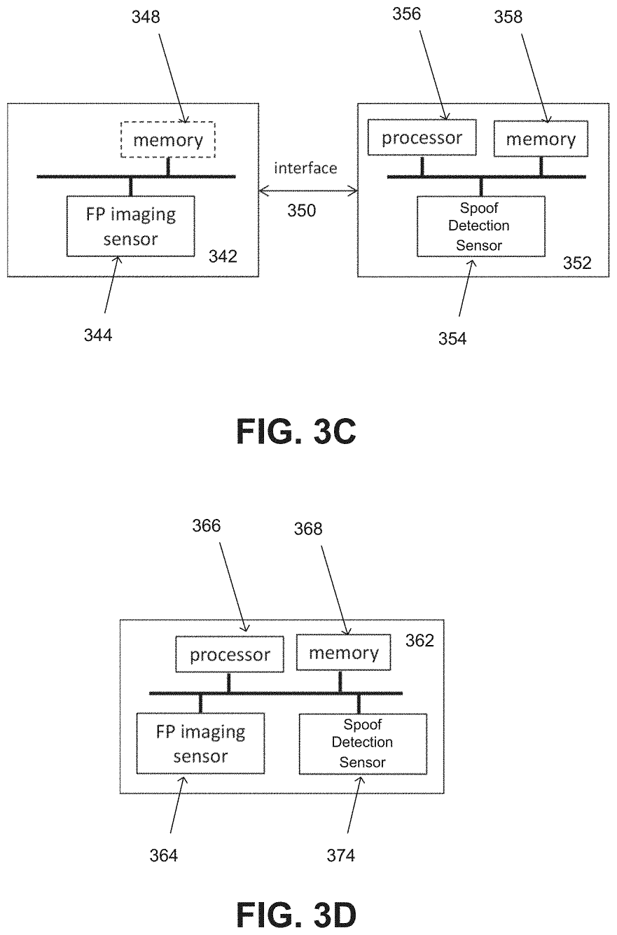

FIGS. 3A through 3D illustrate example hardware configurations of a fingerprint sensing system, according to various embodiments. The fingerprint imaging sensor and the spoof detection sensor may require a sensor processor for operation and memory for storing algorithms, settings, and data. The different components of the fingerprint imaging sensor and the spoof detection sensor may communicate through communication lines and may be integrated together in a sensor processing unit (SPU).

FIG. 3A shows an fingerprint imaging sensor 304 of SPU 302 and spoof detection sensor 314 of SPU 312, where fingerprint imaging sensor 304 has a dedicated sensor processor 306 and sensor memory 308 and spoof detection sensor 314 has a dedicated sensor processor 316 and sensor memory 318. An interface 310 may exist between fingerprint imaging sensor 304 and the spoof detection sensor 314 for direct communication. The interface 310 may contain dedicated communication lines (e.g., to reduce latency, improved security and improve operation). For example, the spoof detection sensor 314 may output a signal indicating the liveness indication, and this output may have a dedicated output pin. In some embodiments, the output/input is cryptographically protected or tokenized to prevent fraud. The fingerprint imaging sensor 304 may have a dedicated input for receiving the liveness indication. Alternatively, the sensors may communicate through an external bus or processor, for example a host processor (not shown).

FIG. 3B shows an embodiment where the spoof detection sensor 334 does not have its own sensor processor, and where the control of the spoof detection sensor 334 is performed by an external processor, e.g., the sensor processor 326 of SPU 322 or a host processor. As illustrated, fingerprint imaging sensor 324 of SPU 322 has a dedicated sensor processor 326 and sensor memory 328 and spoof detection sensor 334 of SPU 332 has a dedicated sensor memory 338. An interface 330 may exist between fingerprint imaging sensor 324 and the spoof detection sensor 334 for direct communication, and operates in a similar manner as interface 310. For example, the spoof detection sensor 334 may output a signal indicating the liveness indication, and this output may have a dedicated output pin. In some embodiments, the output/input is cryptographically protected or tokenized to prevent fraud. The fingerprint imaging sensor 324 may have a dedicated input for receiving the liveness indication. Alternatively, the sensors may communicate through an external bus or processor, for example a host processor (not shown).

FIG. 3C shows an embodiment where the fingerprint imaging sensor 344 does not have its own sensor processor, and where the control of the fingerprint imaging sensor 344 is performed by an external processor, e.g., the sensor processor 356 of SPU 352 or a host processor. As illustrated, fingerprint imaging sensor 344 of SPU 342 has a dedicated sensor memory 348 and spoof detection sensor 354 of SPU 352 has a dedicated sensor processor 356 and sensor memory 358. An interface 350 may exist between fingerprint imaging sensor 344 and the spoof detection sensor 354 for direct communication, and operates in a similar manner as interface 310. For example, the spoof detection sensor 354 may output a signal indicating the liveness indication, and this output may have a dedicated output pin. In some embodiments, the output/input is cryptographically protected or tokenized to prevent fraud. The fingerprint imaging sensor 344 may have a dedicated input for receiving the liveness indication. Alternatively, the sensors may communicate through an external bus or processor, for example a host processor (not shown).

FIG. 3D shows an embodiment where fingerprint imaging sensor 364 and spoof detection sensor 374 are combined in a single SPU 362 with a single sensor processor 366 and sensor memory 368. Any or all functions of the sensor processor 366 may also be performed by an external processor.

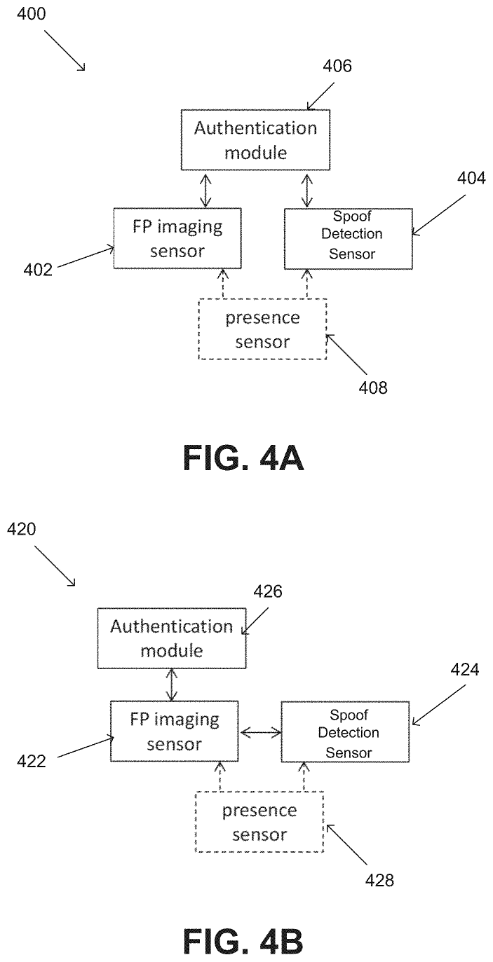

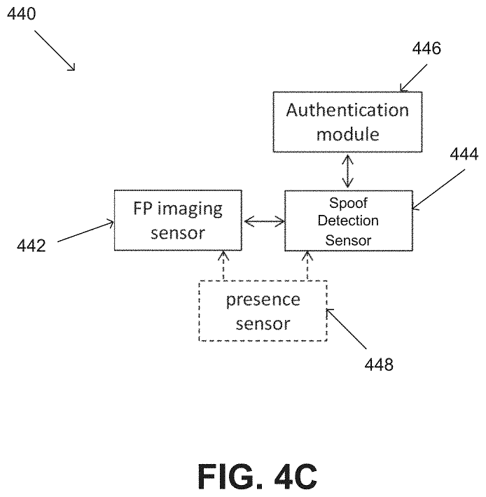

FIGS. 4A through 4C illustrate example configurations of the operation of the fingerprint imaging sensor and a spoof detector sensor in conjunction with an authentication module, according to various embodiments. Operation of the fingerprint sensing system with the fingerprint imaging sensor and the spoof detection sensor may be done in many different ways. FIGS. 4A through 4C shows several example embodiments of how the different sensors and modules may work together. For authentication of the user, the image data from the fingerprint imaging sensor and the liveness data from the spoof detection sensor are both used. The authentication therefore comprises comparing the fingerprint image captured by the fingerprint imaging sensor with the stored fingerprint templates of authorized users and making sure that the captured fingerprint images are from a real finger. The authentication may be done by an authentication module. This authentication module may compare the captured fingerprint image from the fingerprint imaging sensor to the fingerprint images acquired during enrollment (fingerprint templates). The authentication module may also be referred to as a matcher.

As presented above, embodiments described herein provide for authentication of a user using a fingerprint imaging sensor and a spoof detection sensor during a single touch action. A one-touch verification module may be used to check a single finger is touching both sensors. For example, the one touch verification module may monitor the initial contact with the sensor (or the finger lifting), and use the initial stage of the finger press to verify the one-touch. When a finger is starting to be pressed onto the sensors, the signal due to the interaction of the sensors with the finger will increase. When a single finger presses on both sensors at the same time, the signal increase for the image sensor and liveness sensor should show similar characteristics and timing. Through comparison of these characteristics and timing the likelihood or confidence of a one-touch occurring can be determined. If this likelihood of confidence is below a threshold, actions may be taken, such as e.g. not operating the sensor system, asking the user to press again, or adjusting operation of the sensor(s) and increasing security in the verification process.

In some embodiments, the one-touch verification module uses an optional presence sensor that is used to detect if there is a finger present on the sensor. If the presence sensor has detected a finger, it may indicate the finger presence to the fingerprint imaging sensor and/or spoof detection sensor. The use of a presence sensor may use lower resources (battery, processing), and may wake the fingerprint imaging sensor and/or spoof detection sensor from a lower power mode.

FIG. 4A shows an example embodiment of configuration 400 where the fingerprint imaging sensor 402 sends the image data (captured fingerprint image) to the authentication module 406 and the spoof detection sensor 404 sends the liveness data to the authentication module 406. Both fingerprint imaging sensor 402 and the spoof detection sensor 404 interact with the authentication module 406 individually. The authentication module 406 then processes both the image data and the liveness data to authenticate the user and to make sure the captured fingerprint image is not from a fake or spoof finger. The authentication module 406 may also function on one of the fingerprint imaging sensor 402 or spoof detection sensor 404 or may run on an external/host processor. The fingerprint imaging sensor 402 and spoof detection sensor 404 may be operated simultaneously, to minimize latency when a user places a finger on the sensor system. Alternatively, fingerprint imaging sensor 402 and spoof detection sensor 404 may be operated sequentially, where the detection of a finger on one sensor triggers the operation of the other sensor. In some embodiments, configuration 400 includes optional presence sensor 408 that is used to detect if there is a finger present on the presence sensor 408. If the presence sensor 408 has detected a finger, it may indicate the finger presence to the fingerprint imaging sensor 402 and/or spoof detection sensor 404.

FIG. 4B shows an example embodiment of configuration 420 where the communication with the authentication module 426 is through the fingerprint imaging sensor 422. In this example, the fingerprint imaging sensor 422 communicates with the spoof detection sensor 424 and the fingerprint imaging sensor 422 provides all relevant data to the authentication 426. The fingerprint imaging sensor 422 may control operation of the spoof detection sensor 424. For example, the fingerprint imaging sensor 422 may request a liveness determination from the spoof detection sensor 424 once a finger is detected on the fingerprint imaging sensor 422, or once the fingerprint imaging sensor 422 has determined that it has successfully acquired a fingerprint image. In some embodiments, configuration 420 includes optional presence sensor 428 that is used to detect if there is a finger present on the presence sensor 428. If the presence sensor 428 has detected a finger, it may indicate the finger presence to the fingerprint imaging sensor 422.

FIG. 4C shows an example embodiment of configuration 440 where the communication with the authentication module 446 is through the spoof detection sensor 444. In this example, the spoof detection sensor 444 communicates with the fingerprint imaging sensor 442 and the spoof detection sensor 444 provides all relevant data to the authentication module 446. The spoof detection sensor 444 may control operation of the fingerprint imaging sensor 442. For example, the spoof detection sensor 444 may request a fingerprint image capture from the fingerprint imaging sensor 442 once a finger is detected on the spoof detection sensor 444, or once the spoof detection sensor 444 has determined that it has successfully performed a liveness determination. In some embodiments, configuration 440 includes optional presence sensor 448 that is used to detect if there is a finger present on the presence sensor 448. If the presence sensor 448 has detected a finger, it may indicate the finger presence to the spoof detection sensor 444.

Thus far, embodiments have been discussed where the fingerprint imaging sensor provides a fingerprint image that is used to match with fingerprint images acquired during enrollment or other fingerprint templates of authorized users, and where the spoof detection sensor is used to determine if the finger is a real live finger and not a fake or spoof finger. However, in some embodiments the fingerprint imaging sensor may also be used to provide a liveness determination and/or the spoof detection sensor may also be used to provide authentication data to identify the user or look at user characteristics. The data from both sensors may be orthogonally combined to improve authentication and/or liveness determination thereby enabling a much higher security. The liveness characteristics may be stored within the image template, and vice versa. This may also have practical implementation for the size requirements of the fingerprint imaging sensor. As discussed above, normally a certain minimum sensor surface area may be needed to capture a sufficiently large area of the fingerprint. If the spoof detection sensor can also provide some user authentication information, the fingerprint imaging sensor surface area may be below the commonly accepted minimum limit. This has the advantage that a smaller fingerprint sensor system becomes possible with the proposed embodiments.

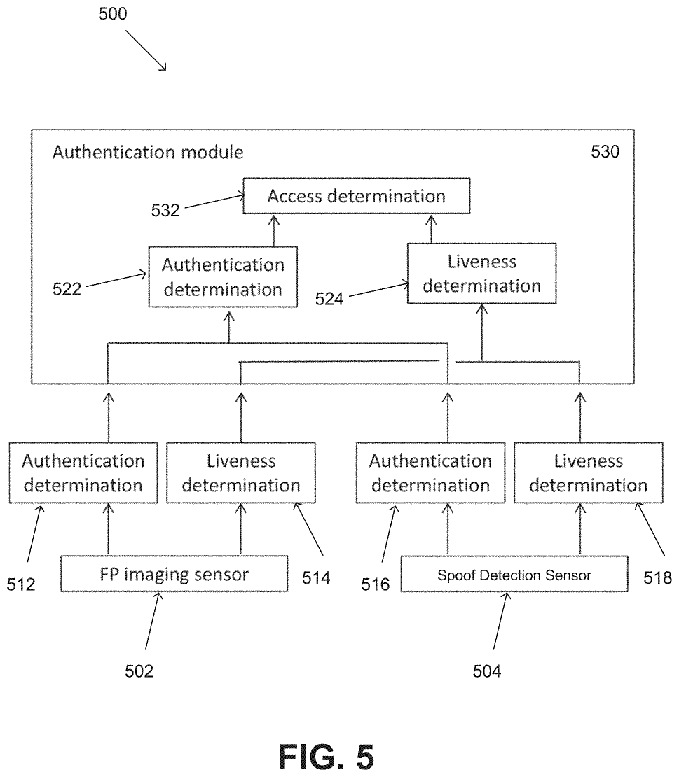

FIG. 5 illustrates an example data flow diagram 500 for user authentication at an authentication module 530 using a fingerprint imaging sensor and a spoof detector sensor, according to some embodiments. In data flow diagram 500, one or both the fingerprint imaging sensor 502 and spoof detection sensor 504 provide authentication data for authentication determinations 512 and 516 (e.g., a user identification) and liveness data for a liveness determination 514 and 518. The authentication data and authentication determinations 512 and 516 may then be combined into an authentication determination 522 based on the two sensors. The liveness data and liveness determinations 514 and 518 may then be combined into a liveness determination 524 based on the two sensors. Access determination 532 and a final user authentication is then determined based on both combined determinations.

For example, the data from the fingerprint imaging sensor 502 may be used to make a liveness determination 514 based on details of the fingerprint image, e.g., ridge/valley profile characteristics, presence and characteristics of pores, etc., as understood by one of ordinary skill in the art. These types of investigations help enhance the possibility of detecting fake finger, although sophisticated fake finger may remain undetected, which is the reason for the need for a separate spoof detection sensor. The data from the spoof detection sensor 504 may be used to authenticate a user based on the liveness data. For example, if the spoof detection sensor 504 is used to acquire blood pressure data, blood flow data, heart rate data, etc., this data may also contain characteristics of a user since blood pressure profiles and heart rate profiles differ from user to user. In another example, if the spoof detection sensor 504 is an ultrasonic sensor, the interaction of the ultrasonic waves with the tissue of the finger of the user may also have certain characteristic that can be used for identification of the user (e.g., comparing to data collected during enrollment).

More generally, any type of interaction with the finger of the user may result in measurable characteristics that may be used for identification. These measured characteristics are then compared to the characteristics acquired during the enrollment of the user. The authentication of the user based on the spoof detection sensor 504 only may not be as reliable and accurate as the authentication using the fingerprint imaging sensor 502, but the combination of the fingerprint imaging sensor 502 and spoof detection sensor 504 can increase the accuracy and confidence in the authentication. When combining the different data from the different sensors, the data may be weighted based on the confidence of the data. For example, in the authentication determination 522, the data from the fingerprint imaging sensor 502 may have a higher weight than the data from the spoof detection sensor 504, while on the other hand, in the liveness determination 524, the data from the spoof detection sensor 504 may have a higher weight than the data from the fingerprint imaging sensor 502. The confidence in the determination data of each individual sensor may also influence the weighing when the data from both sensors is combined.

In some embodiments, the result from one sensor may influence the operating of the other sensor. For example, if the spoof detection sensor determines a high liveness indicator (high confidence), the fingerprint imaging sensor may only be used to capture the fingerprint image for matching with fingerprint templates of users with access. Consequently, the configuration of the fingerprint imaging sensor may be modified for a lower resolution, lower SNR/CNR, smaller images, less averaging, etc. On the other hand, if the spoof detection sensor determines a low liveness factor (low confidence), the fingerprint sensing system may use the fingerprint imaging sensor for additional liveness investigation. This may take more resources and/or more time, and may therefore only be done when the spoof detection sensor has a low confidence that the finger is not a fake or spoof finger. For example, the fingerprint imaging sensor may need to acquire more data, for example, for a higher resolution, deeper layers, better SNR or CNR, etc. As such, results from the spoof detection sensor may be used to determine the setting of the fingerprint imaging sensor. The inverse may also be used. For example, the fingerprint imaging sensor may use the captured image to determine a liveness indication. Only if the liveness indication is low, or the confidence is low, the system may engage the spoof detection sensor for further investigation. This type of solution may be used if the spoof detection sensor takes more resources or more time.

In some embodiments, the liveness data and indication may be location dependent. For example, the characteristics of the finger may be different at different location of the finger. This may influence the liveness determination of the spoof detection sensor. In this case, the location of the spoof detection sensor may be determined using the fingerprint imaging sensor.

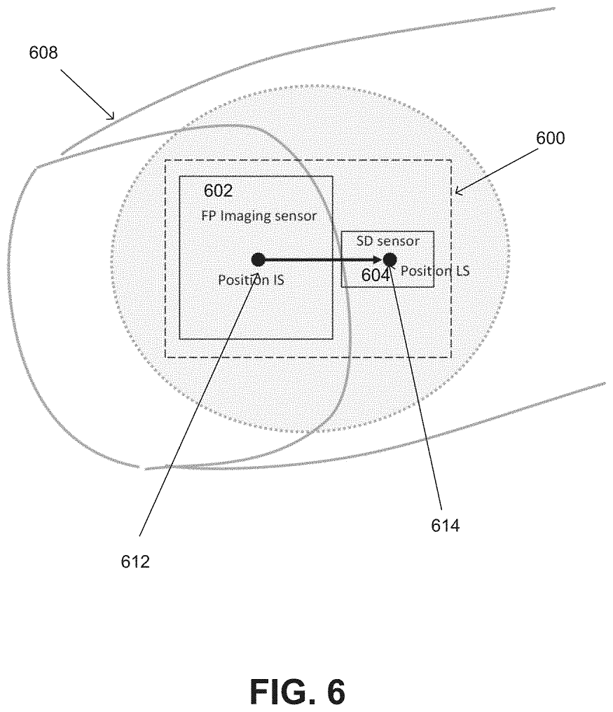

FIG. 6 illustrates an example of a fingerprint sensing system 600 configured to determine a location of a finger 608 in determining liveness, according to some embodiments. The image captured by the fingerprint imaging sensor 602 may be used to determine the position (and orientation) 612 of the sensors within the finger if a larger area has been stored during enrollment. Based on the known layout between the fingerprint imaging sensor 602 and the spoof detection sensor 604, the position 614 of the spoof detection sensor 604 can be determined based on the position and orientation of the fingerprint imaging sensor 602 and the relative position of both sensors. As such, fingerprint sensing system 600 can determine the location of the liveness data, and correlate with location dependent data acquired during enrollment. Fingerprint sensing system 600 may also check if the spoof detection sensor 604 is in an appropriate location, and if not, ask the user to correctly position the finger 608 for the liveness measurements.

### Example Operations for Operating a System for Fingerprint Authentication Using a Fingerprint Imaging Sensor and a Spoof Detector Sensor

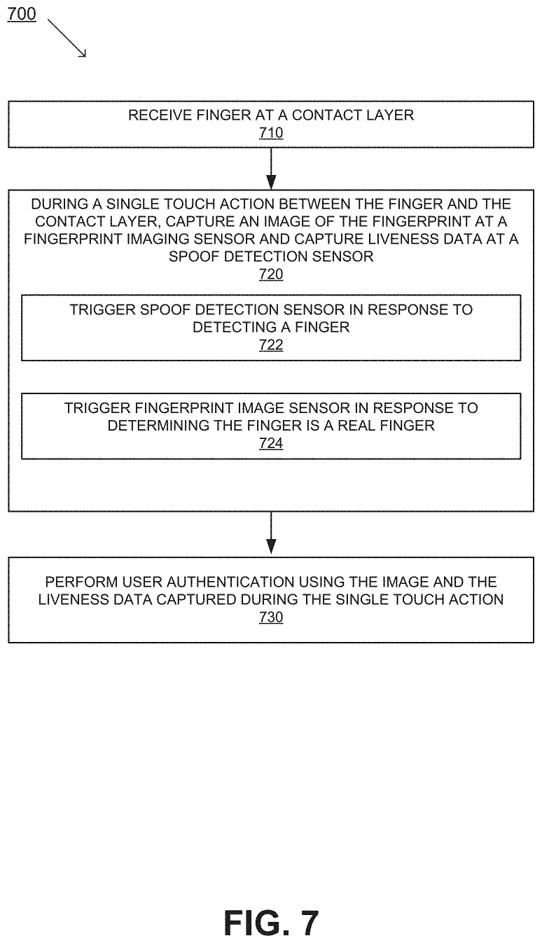

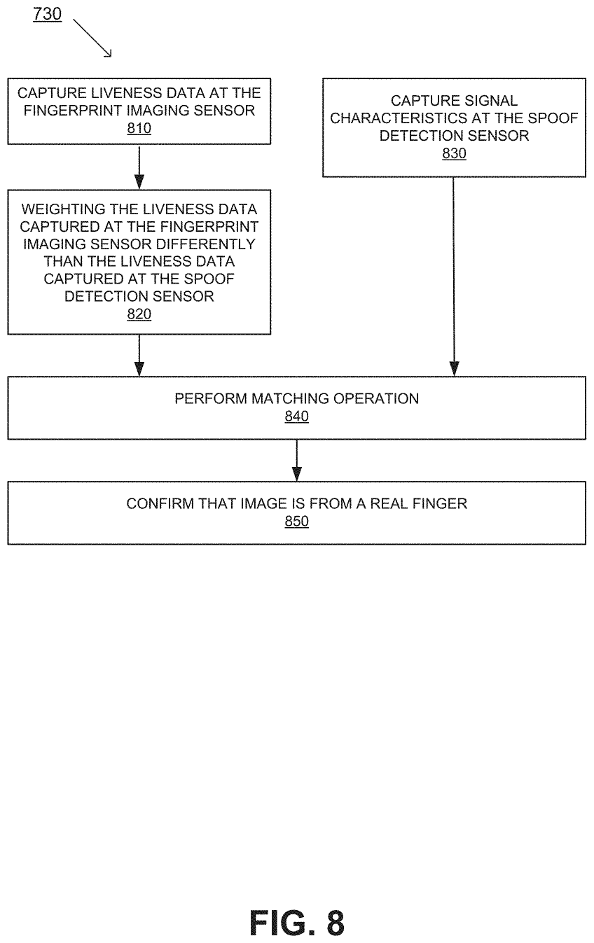

FIGS. 7 and 8 illustrate flow diagrams of example methods for authenticating a fingerprint at a fingerprint authentication system, according to various embodiments. Procedures of these methods will be described with reference to elements and/or components of various figures described herein. It is appreciated that in some embodiments, the procedures may be performed in a different order than described, that some of the described procedures may not be performed, and/or that one or more additional procedures to those described may be performed. The flow diagrams include some procedures that, in various embodiments, are carried out by one or more processors (e.g., a host processor or a sensor processor) under the control of computer-readable and computer-executable instructions that are stored on non-transitory computer-readable storage media. It is further appreciated that one or more procedures described in the flow diagrams may be implemented in hardware, or a combination of hardware with firmware and/or software.

With reference to FIG. 7, flow diagram 700 illustrates an example process for authenticating a fingerprint at a fingerprint authentication system, according to some embodiments. At procedure 710 of flow diagram 700, a finger of a user is received at a contact layer of the fingerprint authentication system, the contact layer overlying a fingerprint imaging sensor comprising a two-dimensional array of ultrasonic transducers and a spoof detector sensor comprising at least one ultrasonic transducer. In one embodiment, a layout of the contact layer, the fingerprint imaging sensor and the spoof detector sensor is such that the finger interacts with both the fingerprint imaging sensor and the spoof detector sensor during the user authentication operation using the single touch action.

At procedure 720, during a single touch action between the finger and the contact layer, wherein the single touch action is a single contact between the finger and the contact layer, an image of a fingerprint of the finger is captured at the fingerprint imaging sensor and data used to determine whether the finger is a real finger (e.g., liveness data) is captured at the spoof detector sensor. In one embodiment, the capturing the image of the fingerprint of the finger at the fingerprint imaging sensor and the capturing the data used to determine whether the finger is a real finger at the spoof detector sensor are performed concurrently during the single contact between the finger and the contact layer of the fingerprint authentication system.

In one embodiment, as shown at procedure 722, activation of the capturing the data used to determine whether the finger is a real finger at the spoof detector sensor is triggered in response to detecting the finger interacting with the fingerprint authentication system. In one embodiment, as shown at procedure 724, activation of the capturing the image of the fingerprint of the finger at the fingerprint imaging sensor is triggered in response to determining that the finger is a real finger during the single touch action.

At procedure 730, a user authentication operation using the image of the fingerprint as captured by the fingerprint imaging sensor and the data used to determine whether the finger is a real finger as captured at the spoof detector sensor, wherein the user authentication operation is for authenticating a user using the single touch action.

In some embodiments, procedure 730 is performed according to the procedures of flow diagram 800 of FIG. 8. Flow diagram 800 illustrates an example process for performing a user authentication operation, according to some embodiments. In one embodiment, as shown at procedure 810, data used to determine whether the finger is a real finger (e.g., liveness data) is captured at the fingerprint imaging sensor. At procedure 820, the data used to determine whether the finger is a real finger captured at the fingerprint imaging sensor is weighted differently than the data used to determine whether the finger is a real finger captured at the spoof detector sensor. In one embodiment, as shown at procedure 830, signal characteristics data for use during the matching operation of the user authentication operation are captured at the spoof detector sensor.

In one embodiment, as shown at procedure 840, a matching operation is performed comparing the image of the fingerprint captured at the fingerprint imaging sensor to a stored fingerprint image of an authenticated user. At procedure 850, confirmation that the image of the fingerprint is from a real finger based on the data used to determine whether the finger is a real finger captured at the spoof detector sensor is performed. In some embodiments, a location of the finger relative to the fingerprint imaging sensor and the spoof detector sensor is used in performing user authentication.

### CONCLUSION

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. Many aspects of the different example embodiments that are described above can be combined into new embodiments. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed is:

1. A fingerprint authentication system comprising:
a fingerprint imaging sensor comprising a two-dimensional array of ultrasonic transducers, the fingerprint imaging sensor for capturing an image of a fingerprint of a finger;
a spoof detector sensor comprising at least one ultrasonic transducer, the spoof detector sensor for capturing data used to determine whether the finger is a real finger;
a contact layer overlying the fingerprint imaging sensor and the spoof detector sensor, the contact layer for receiving the finger of a user; and
a processor, wherein the processor is configured to perform a user authentication operation using the fingerprint imaging sensor and the spoof detector sensor, wherein the user authentication operation is for authenticating a user using a single touch action.

2. The fingerprint authentication system of claim 1, wherein the single touch action is a single contact between the finger and the fingerprint authentication system.

3. The fingerprint authentication system of claim 1, wherein a layout of the contact layer, the fingerprint imaging sensor and the spoof detector sensor is such that the finger interacts with both the fingerprint imaging sensor and the spoof detector sensor during the user authentication operation using the single touch action.

4. The fingerprint authentication system of claim 1, wherein the fingerprint imaging sensor and the spoof detector sensor operate concurrently during a single contact between the finger and the fingerprint authentication system.

5. The fingerprint authentication system of claim 1, wherein the fingerprint imaging sensor triggers activation of the spoof detector sensor during the user authentication operation in response to detecting the finger interacting with the fingerprint authentication system.

6. The fingerprint authentication system of claim 1, wherein the spoof detector sensor triggers activation of the fingerprint imaging sensor during the user authentication operation in response to determining that the finger is a real finger during the single touch action.

7. The fingerprint authentication system of claim 1, wherein the user authentication operation comprises:
performing a matching operation comparing the image of the fingerprint captured at the fingerprint imaging sensor to a stored fingerprint image of an authenticated user; and
confirming that the image of the fingerprint is from a real finger based on the data used to determine whether the finger is a real finger captured at the spoof detector sensor.

8. The fingerprint authentication system of claim 7, wherein the fingerprint imaging sensor also captures data used to determine whether the finger is a real finger.

9. The fingerprint authentication system of claim 8, wherein the user authentication operation comprises:
weighting the data used to determine whether the finger is a real finger captured at the fingerprint imaging sensor differently than the data used to determine whether the finger is a real finger captured at the spoof detector sensor.

10. The fingerprint authentication system of claim 7, wherein the spoof detector sensor also captures signal characteristics data for use during the matching operation of the user authentication operation.

11. The fingerprint authentication system of claim 1, wherein the user authentication operation comprises:
using a location of the finger relative to the fingerprint imaging sensor and the spoof detector sensor in performing user authentication.

12. A method for authenticating a fingerprint at a fingerprint authentication system, the method comprising:
receiving a finger of a user at a contact layer of the fingerprint authentication system, the contact layer overlying a fingerprint imaging sensor comprising a two-dimensional array of ultrasonic transducers and a spoof detector sensor comprising at least one ultrasonic transducer;
during a single touch action between the finger and the contact layer, wherein the single touch action is a single contact between the finger and the contact layer:
capturing an image of a fingerprint of the finger at the fingerprint imaging sensor; and
capturing data used to determine whether the finger is a real finger at the spoof detector sensor; and
performing a user authentication operation using the image of the fingerprint as captured by the fingerprint imaging sensor and the data used to determine whether the finger is a real finger as captured at the spoof detector sensor, wherein the user authentication operation is for authenticating a user using the single touch action.

13. The method of claim 12, wherein a layout of the contact layer, the fingerprint imaging sensor and the spoof detector sensor is such that the finger interacts with both the fingerprint imaging sensor and the spoof detector sensor during the user authentication operation using the single touch action.

14. The method of claim 12, wherein the capturing the image of the fingerprint of the finger at the fingerprint imaging sensor and the capturing the data used to determine whether the finger is a real finger at the spoof detector sensor are performed concurrently during the single contact between the finger and the contact layer of the fingerprint authentication system.

15. The method of claim 12, further comprising:
triggering activation of the capturing the data used to determine whether the finger is a real finger at the spoof detector sensor in response to detecting the finger interacting with the fingerprint authentication system.

16. The method of claim 12, further comprising:
triggering activation of the capturing the image of the fingerprint of the finger at the fingerprint imaging sensor in response to determining that the finger is a real finger during the single touch action.

17. The method of claim 12, wherein the performing a user authentication operation using the image of the fingerprint as captured by the fingerprint imaging sensor and the data used to determine whether the finger is a real finger as captured at the spoof detector sensor comprises:
performing a matching operation comparing the image of the fingerprint captured at the fingerprint imaging sensor to a stored fingerprint image of an authenticated user; and
confirming that the image of the fingerprint is from a real finger based on the data used to determine whether the finger is a real finger captured at the spoof detector sensor.

18. The method of claim 17, wherein the performing a user authentication operation using the image of the fingerprint as captured by the fingerprint imaging sensor and the data used to determine whether the finger is a real finger as captured at the spoof detector sensor further comprises:
capturing data used to determine whether the finger is a real finger at the fingerprint imaging sensor; and
weighting the data used to determine whether the finger is a real finger captured at the fingerprint imaging sensor differently than the data used to determine whether the finger is a real finger captured at the spoof detector sensor.

19. The method of claim 17, wherein the performing a user authentication operation using the image of the fingerprint as captured by the fingerprint imaging sensor and the data used to determine whether the finger is a real finger as captured at the spoof detector sensor further comprises:
capturing signal characteristics data for use during the matching operation of the user authentication operation at the spoof detector sensor.

20. The method of claim 12, wherein the performing a user authentication operation using the image of the fingerprint as captured by the fingerprint imaging sensor and the data used to determine whether the finger is a real finger as captured at the spoof detector sensor further comprises:
using a location of the finger relative to the fingerprint imaging sensor and the spoof detector sensor in performing user authentication.
